(19) United States
(12) Patent Application Publication
(10) Pub. No.: US 2025/0317064 A1
(43) Pub. Date: Oct. 9, 2025

(54) CONTROLLER

(71) Applicant: DENSO CORPORATION, Kariya-city (JP)

(72) Inventor: NAOKI OOARATA, Kariya-city (JP)

(21) Appl. No.: 19/242,541

(22) Filed: Jun. 18, 2025

Related U.S. Application Data
(63) Continuation of application No. PCT/JP2023/043146, filed on Dec. 1, 2023.

(30) Foreign Application Priority Data
Dec. 22, 2022 (JP) 2022-205861

(51) Int. Cl. H02M 3/335; B60L 3/00

(52) U.S. Cl. CPC H02M 3/33507; B60L 3/0023; B60L 2210/10

(57) ABSTRACT

A controller controls a switching converter configured to convert a power voltage to a supply voltage according to a switching frequency of the switching converter. The supply voltage is supplied to an in-vehicle device. The controller includes a monitoring unit and a voltage control unit. The monitoring unit is configured to monitor a time variation of the supply voltage. The voltage control unit is configured to execute a voltage control in which at least one of a rise time or a fall time of a voltage in the switching converter is controlled based on the time variation of the supply voltage.

### CROSS REFERENCE TO RELATED APPLICATION

The present application is a continuation application of International Patent Application No. PCT/JP2023/043146 filed on Dec. 1, 2023, which designated the U.S. and claims the benefit of priority from Japanese Patent Application No. 2022-205861 filed on Dec. 22, 2022. The entire disclosures of all the above applications are incorporated herein by reference.

### TECHNICAL FIELD

The present disclosure relates to a control technique for controlling a switching converter.

### BACKGROUND

There is a switching device configured to perform switching control in which a power switching element is repeatedly turned on and off.

### SUMMARY

A first aspect of the present disclosure is a controller configured to control a switching converter. The switching converter is configured to convert a power voltage to a supply voltage according to a switching frequency of the switching converter. The supply voltage is supplied to an in-vehicle device. The controller includes a monitoring unit and a voltage control unit. The monitoring unit is configured to monitor a time variation of the supply voltage. The voltage control unit is configured to execute a voltage control in which at least one of a rise time or a fall time of a voltage in the switching converter is controlled based on the time variation of the supply voltage.

A second aspect of the present disclosure is a controller configured to control a switching converter. The switching converter is configured to convert a power voltage to a supply voltage according to a switching frequency of the switching converter. The supply voltage is supplied to an in-vehicle device. The controller includes a monitoring unit and a voltage control unit. The monitoring unit is configured to monitor a time variation of the supply voltage. The voltage control unit is configured to execute a voltage control in which the switching frequency is controlled based on the time variation of the supply voltage. The voltage control unit is configured to execute the voltage control based on the time variation falling within an acceptable variation range of the in-vehicle device.

### BRIEF DESCRIPTION OF THE DRAWINGS

FIG. 1 is a block diagram illustrating an overall configuration according to a first embodiment.

FIG. 2 is a schematic diagram illustrating an example of a DC-DC converter according to the first embodiment.

FIG. 3 is a schematic diagram showing a configuration of a gate resistor circuit in the first embodiment.

FIG. 4 is a table showing an example of the state of a gate resistor circuit and the magnitude of a gate resistance value.

FIG. 5 is a graph showing an example of a voltage of the primary circuit.

FIG. 6 is a graph showing an example of a supply voltage.

FIG. 7 is a block diagram showing a functional configuration of a controller of the first embodiment.

FIG. 8 is a flowchart showing a control flow according to the first embodiment.

FIG. 9 is a flowchart showing the control flow according to the first embodiment.

FIG. 10 is a flowchart showing the control flow according to the first embodiment.

FIG. 11 is a flowchart showing the control flow according to the first embodiment.

FIG. 12 is a flowchart showing a control flow according to a second embodiment.

### DESCRIPTION OF EMBODIMENTS

To begin with, examples of relevant techniques will be described.

The present disclosure relates to a control technique for controlling a switching converter.

There is a switching device configured to perform switching control in which a power switching element is repeatedly turned on and off. The switching device shifts the start timing of the on period by repeating a basic pattern, which includes various shift amounts, for a basic period. Additionally, the switching device sets a diffusion frequency, which is the inverse of the period of the repeating basic pattern, to a frequency above a frequency in the audible range. Thereby, the switching device spreads the switching frequency.

In the technique described above, noise can be reduced by spreading out the switching frequency. However, spreading the switching frequency may result in a decrease in the stability of the supply voltage from the switching device. So far, there has been no disclosure on achieving both noise reduction and supply voltage stability.

The present disclosure provides a controller that can achieve both noise reduction and supply voltage stability. The present disclosure also provides a controller. The present disclosure provides a control method. The present disclosure provides a control program.

Hereinafter, a technical solution of the present disclosure to address the above described objectives will be described.

A first aspect of the present disclosure is a controller configured to control a switching converter. The switching converter is configured to convert a power voltage to a supply voltage according to a switching frequency of the switching converter. The supply voltage is supplied to an in-vehicle device. The controller includes a monitoring unit and a voltage control unit. The monitoring unit is configured to monitor a time variation of the supply voltage. The voltage control unit is configured to execute a voltage control in which at least one of a rise time or a fall time of a voltage in the switching converter is controlled based on the time variation of the supply voltage.

According to this aspect, at least one of the rise time or the fall time of the voltage in the switching converter is controlled based on the time variation of the supply voltage. That is, noise reduction control by controlling at least one of the rise time or the fall time is executed taking into account the time variation of the voltage supplied to the in-vehicle device. Thus, it is possible to achieve both noise reduction and supply voltage stability.

A second aspect of the present disclosure is a controller configured to control a switching converter. The switching converter is configured to convert a power voltage to a supply voltage according to a switching frequency of the switching converter. The supply voltage is supplied to an in-vehicle device. The controller includes a monitoring unit and a voltage control unit. The monitoring unit is configured to monitor a time variation of the supply voltage. The voltage control unit is configured to execute a voltage control in which the switching frequency is controlled based on the time variation of the supply voltage. The voltage control unit is configured to execute the voltage control based on the time variation falling within an acceptable variation range of the in-vehicle device.

According to this aspect, at least one of the rise time or the fall time of the voltage in the switching converter is controlled based on the time variation of the supply voltage. Thus, noise reduction control by controlling the switching frequency is executed taking into account the time variation in the voltage supplied to the in-vehicle device. Thus, it is possible to achieve both noise reduction and supply voltage stability.

The following will describe embodiments of the present disclosure with reference to the drawings. Elements corresponding to each other among the embodiments are assigned the same numeral and their descriptions may be omitted. When only a part of a component is described in an embodiment, the other part of the component can be relied on the component of a preceding embodiment. Furthermore, in addition to the combination of components explicitly described in each embodiment, it is also possible to combine components from different embodiments, as long as the combination poses no difficulty, even if not explicitly described.

### First Embodiment

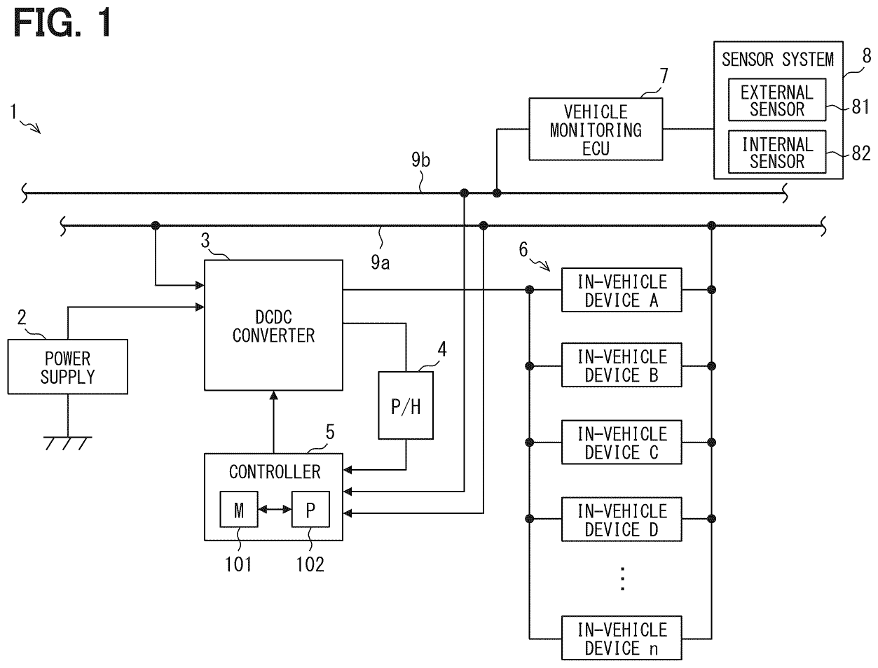

A vehicle system 1 of a first embodiment illustrated in FIG. 1 is installed in a vehicle. The vehicle is a mobile body, such as an automobile, that is capable of traveling on a road. The vehicle system 1 includes a power supply 2, a DC-DC converter 3, a peak hold circuit 4, multiple in-vehicle devices 6, a vehicle monitoring ECU 7, a sensor system 8, and a controller 5. Furthermore, components in the vehicle system 1 are communicatively connected to each other through a first communication bus 9a and a second communication bus 9b. As a result, the first communication bus 9a and the second communication bus 9b provide communication via a CAN (registered trademark) network that complies with the CAN communication protocol. Alternatively, the first communication bus 9a and the second communication bus 9b may provide communication through a network conforming to another communication protocol such as Ethernet (registered trademark). The DC-DC converter 3, the controller 5, and the in-vehicle devices 6 are connected to the first communication bus 9a. The controller 5 and the vehicle monitoring ECU 7 are connected to the second communication bus 9b.

The power supply 2 is a source of power for the in-vehicle devices 6. The power supply 2 may be a rechargeable vehicle battery. The power supply 2 is electrically connected to the DC-DC converter 3 via a wire harness or the like, and supplies DC power to the DC-DC converter 3.

The DC-DC converter 3 generates a pulse waveform voltage by switching the input DC voltage, and smooths the pulse waveform voltage, thereby converting the voltage into a DC voltage of a different magnitude. The DC-DC converter 3 is electrically connected to the power supply 2 and the in-vehicle devices 6. The DC-DC converter 3 in this embodiment is a step-down converter that steps down the input voltage from the power supply 2 and supplies the stepped-down voltage to each of the in-vehicle devices 6. The DC-DC converter 3 is an example of a “switching converter”.

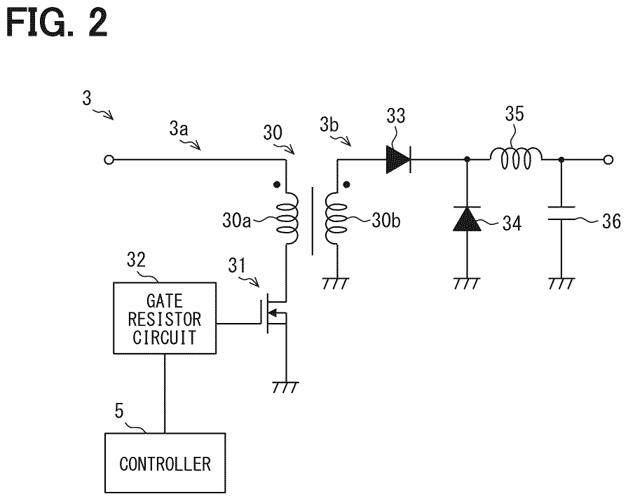

The DC-DC converter 3 includes a primary circuit 3a to which a voltage is input from the power supply 2, and a secondary circuit 3b which outputs a supply voltage to the in-vehicle devices 6. The DC-DC converter 3 in this embodiment is an insulated type in which the primary circuit 3a and the secondary circuit 3b are insulated from each other by a transformer 30. As shown in FIG. 2, the DC-DC converter 3 in this embodiment is of a forward type, but may be configured as other circuit types, such as a flyback type.

The primary circuit 3a includes a primary winding 30a of the transformer 30, a switching element 31, and a gate resistor circuit 32. The switching element 31 switches between flowing and blocking of current from the power supply 2 in the primary circuit 3a. The switching element 31 is, for example, a MOS-FET. The switching element 31 has a gate side that is connected to the controller 5 through the gate resistor circuit 32.

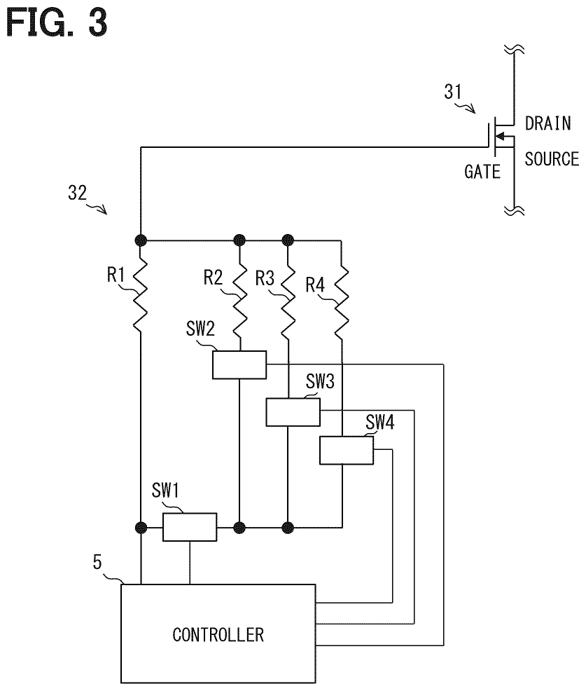

As shown in FIG. 3, the gate resistor circuit 32 includes multiple resistors R1, R2, R3, and R4, and multiple switches SW1, SW2, SW3, and SW4 that can be switched between a current flowing state and a current blocking state. Specifically, the gate resistor circuit 32 includes a first resistor R1, a second resistor R2, a third resistor R3, and a fourth resistor R4 that are connected in parallel with each other. The gate resistor circuit 32 includes a first switch SW1, a second switch SW2, a third switch SW3, and a fourth switch SW4. The first switch SW1 is connected in parallel with the first resistor R1 and in series with the other resistors R2, R3, and R4. The second switch SW2 is connected in series with the second resistor R2 and in parallel with the other resistors R1, R3, and R4. The third switch SW3 is connected in series with the third resistor R3 and in parallel with the other resistors R1, R2, and R4. The fourth switch SW4 is connected in series with the fourth resistor R4 and in parallel with the other resistors R1, R2, and R3.

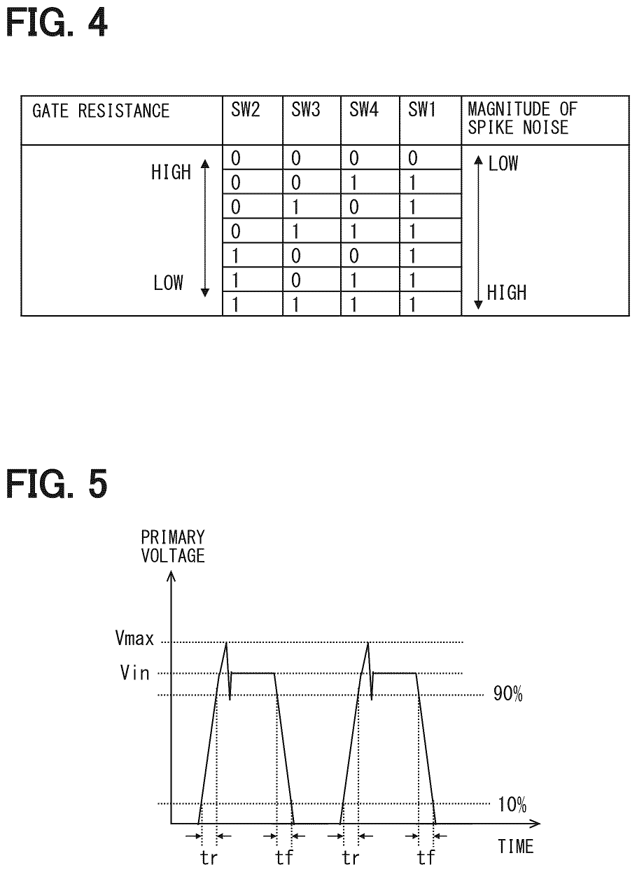

The total resistance of the entire gate resistor circuit 32, that is, the gate resistance, is determined by a combination of the on and off states of the switches SW1, SW2, SW3, and SW4. The resistance of each of the resistors R1, R2, R3, and R4 is determined so that the gate resistance can be adjusted in stages according to the total number of combinations of the on and off states of the switches SW1, SW2, SW3, and SW4. For example, the resistance of the resistors R1, R2, R3, and R4 are specified as shown in FIG. 4 to realize seven stages of gate resistance values according to combinations of the on and off states of the switches SW1, SW2, SW3, and SW4. In the table of FIG. 4, “0” indicates the off state of the switches SW1, SW2, SW3, and SW4, and “1” indicates the on state.

When the gate resistance value is adjusted stepwise by the gate resistor circuit 32, the charging time to the gate capacitance of the switching element 31 is changed according to the gate resistance value. This changes the rising rate of the gate voltage. The turn-on speed of the switching element 31 is controlled according to the rising speed of the gate voltage. Thus, the rise time tr and fall time tf of the voltage in the primary circuit 3a can be controlled by the switching element 31.

The rise time tr here is the time it takes for the voltage (e.g., drain voltage) in the primary circuit 3a to rise from 10% to 90% of the maximum voltage, as shown in FIG. 5. The fall time tf is the time it takes for the voltage in the primary circuit 3a to fall from 90% to 10% of the maximum voltage. Such rise time tr and fall time tf can also be called a slew rate.

The secondary circuit 3b includes a secondary winding 30b of the transformer 30, a first diode 33, a second diode 34, a choke coil 35 and an output capacitor 36. When the switching element 31 in the primary circuit 3a is turned on, that is, is in the current flowing state, an induced electromotive force is generated on the secondary side of the transformer 30 in the secondary circuit 3b. As a result, a current flows from the secondary winding 30b to the output capacitor 36 and the external output through the first diode 33 and the choke coil 35. The choke coil 35 stores energy of the current. When the switching element 31 in the primary circuit 3a is turned off, that is, in the current blocking state, a current flows in the secondary circuit 3b from the choke coil 35 to the output capacitor 36, the external output, and the second diode 34. As a result of the above, the pulse voltage generated in the primary circuit 3a is smoothed and stepped down in the secondary circuit 3b, and is output to the outside as a supply voltage.

The peak hold circuit 4 is a circuit that holds the maximum value of the voltage in the DC-DC converter 3 for a predetermined period. In this embodiment, the peak hold circuit 4 acquires the voltage in the primary circuit 3a. The peak hold circuit 4 outputs the acquired maximum value of the voltage to the controller 5.

The in-vehicle devices 6 are driven with power supplied from the power supply 2 as input power via the DC-DC converter 3. Each of the in-vehicle devices 6 detects the supply voltage input thereto and outputs the detected supply voltage to the first communication bus 9a. Each of the in-vehicle devices 6 has an allowable time variation for the supply voltage input thereto.

The vehicle monitoring ECU 7 collects sensor information from the sensor system 8 to monitor the situation of the vehicle. The vehicle monitoring ECU 7 can provide the collected sensor information or vehicle information generated based on the sensor information to the controller 5 via the second communication bus 9b.

The sensor system 8 acquires sensor information, which is to be used by the controller 5, by detecting an external environment and an internal environment of the vehicle. The sensor system 8 includes an external sensor 81 and an internal sensor 82.

The external sensor 81 acquires external environment information, as sensor information, from the outside that is the surrounding environment of the vehicle. The external sensor 81 may be of an object detection type, which detects an object existing in the external environment of the vehicle. Such object-detecting type external sensor 81 may be at least one of a camera, a Light Detection and Ranging/Laser Imaging Detection and Ranging (i.e., LiDAR), a radar, or a sonar. The external sensor 81 may be of a positioning type that receives a positioning signal from an artificial satellite of a global navigation satellite system (i.e., GNSS) located in the external environment of the vehicle. The external sensors of a positioning type is, for example, a GNSS receiver or the like. The external sensor 81 may be of a V2X type that exchanges communication signals with a Vehicle to Everything (i.e., V2X) system located in the external environment of the vehicle. The external sensor 81 of the communication type is, for example, at least one of a Dedicated Short Range Communications (i.e., DSRC) communication device, a cellular V2X (i.e., C-V2X) communication device, a Bluetooth (registered trademark) device, a Wi-Fi (registered trademark) device, or an infrared communication device.

The internal sensor 82 acquires internal information as sensor information from the internal environment, which is the internal environment of the vehicle. The internal sensor 82 may be of a physical quantity-detecting type which detects a specific physical quantity of motion in the internal environment of the vehicle. Such physical quantity-detecting type internal sensor 82 may be at least one of a driving speed sensor, an acceleration sensor, or a gyro sensor.

The controller 5 is connected to the DC-DC converter 3, the peak hold circuit 4, the in-vehicle devices 6, and in-vehicle ECU through at least one of a Local Area Network (i.e., LAN) line, a wire harness, an internal bus, or a wireless communication line. The controller 5 includes at least one special purpose computer.

The dedicated computer constituting the controller 5 may include at least one memory 101 and at least one processor 102. The memory 101 is at least one type of non-transitory tangible storage medium, which stores computer readable programs and data in non-transitory manner, such as a semiconductor memory, a magnetic medium, and an optical medium. Here, the storage may refer to storage where data is retained even when the vehicle is turned off, or the storage may refer to temporary storage where data is erased when the vehicle is turned off. The processor 102 includes, as a processing core, at least one type of a Central Processing Unit (CPU), a Graphics Processing Unit (GPU), a Reduced Instruction Set Computer (RISC)-CPU, a Data Flow Processor (DFP), or a Graph Streaming Processor (GSP).

The processor 102 of the controller 5 executes multiple instructions included in a control program that is stored in the memory 101 to control the DC-DC converter 3. Thereby, the controller 5 constructs multiple functional blocks for controlling the DC-DC converter 3. As shown in FIG. 7, the functional blocks constructed by the controller 5 include a monitoring block 110 and an output block 120. The monitoring block 110 is an example of a “monitoring unit”, and the output block 120 is an example of a “voltage control unit”.

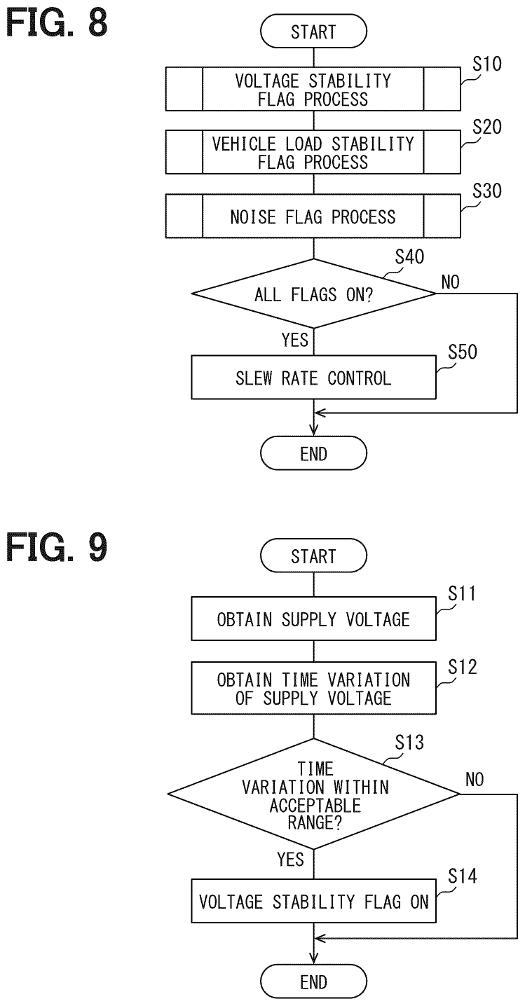

The control method in which the controller 5 controls the DC-DC converter 3 with the blocks 110 and 120 is executed according to the control flow shown in FIGS. 8 to 11. This control flow is repeatedly executed while the vehicle is activated. Here, in this flow, “S” means steps of the process executed by instructions included in the control program.

First, in S10 of FIG. 8, a voltage stability flag process is executed. The process of S10 will be described in detail with reference to the sub-flow in FIG. 9. First, in S11, the monitoring block 110 acquires the supply voltage supplied from the DC-DC converter 3 to the in-vehicle device 6 connected to the DC-DC converter 3. For example, the monitoring block 110 may acquire the input voltage to the in-vehicle device 6. Alternatively, the monitoring block 110 may acquire the input voltage to an IC chip in the in-vehicle device 6. The monitoring block 110 acquires the supply voltage from each of the multiple in-vehicle devices 6.

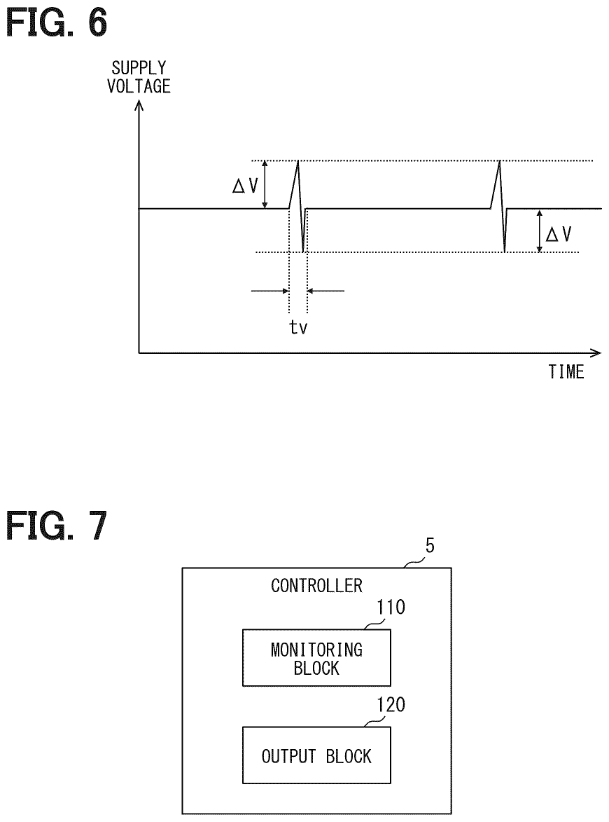

In the next step S12, the monitoring block 110 obtains the time variation of the supply voltage. In the example shown in FIG. 6, spike noise occurs in the supply voltage during a noise occurrence period tv. This spike noise is an instantaneous noise that causes a voltage rise or fall of ΔV (for example, 4 V) relative to a reference value of the supply voltage (for example, 12 V) during the noise occurrence period tv. This noise in the supply voltage is caused by, for example, a spike noise in the primary circuit 3a of the DC-DC converter 3. To detect such noise, the monitoring block 110 periodically calculates a time derivative of the supply voltage, and obtains the derivative as the time variation. The monitoring block 110 may calculate the time derivative by taking the time derivative of the supply voltage based on the time span of the minimum input voltage guaranteed for the corresponding in-vehicle device 6. The monitoring block 110 acquires the time variation for each of the in-vehicle devices 6.

Then, in S13, the monitoring block 110 determines whether the acquired time variation falls within an acceptable variation range. The acceptable variation range is a range that is equal to or less than the threshold of the time variation guaranteed for the corresponding in-vehicle device 6. The monitoring block 110 executes a determination on the time variation of the in-vehicle device 6 that has the smallest acceptable variation range among the time variations acquired for each in-vehicle device 6. The in-vehicle device 6 that has the smallest acceptable variation range corresponds to a specific in-vehicle device 6.

If it is determined that the time variation falls within the acceptable variation range, the monitoring block 110 sets the voltage stability flag to ON in S14. On the other hand, if it is determined that the time variation falls outside the acceptable variation range, S14 is skipped, and the sub-flow ends with the voltage stability flag being OFF.

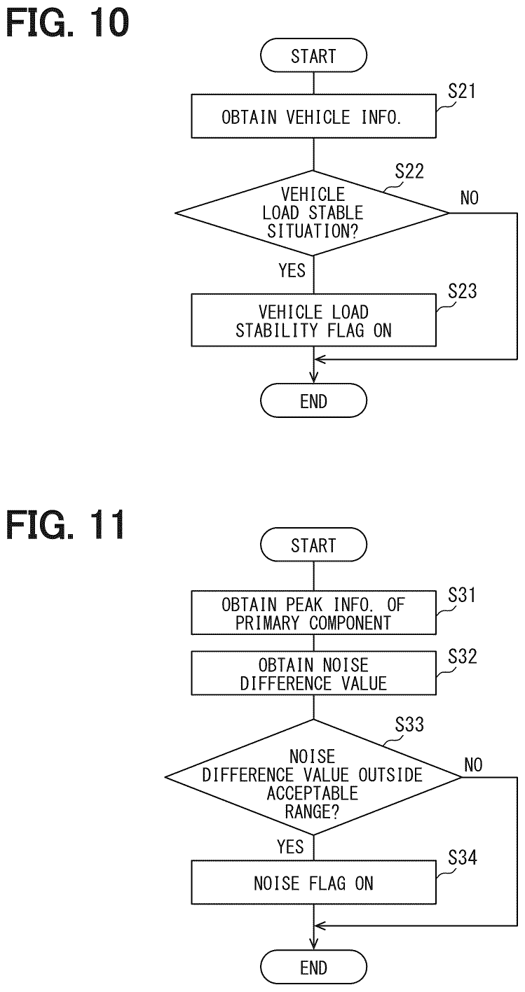

Returning to FIG. 8, in S20, a vehicle load stability flag process is executed. The flag process will be explained in detail with reference to the sub-flow in FIG. 10. First, in S21, the monitoring block 110 acquires vehicle information. In S22, the monitoring block 110 determines whether the current situation corresponds to a stable load situation based on the vehicle information. The stable load situation is a situation where a stable load condition is established. The stable load condition is established when variation of the load current in the vehicle falls within an allowable range. The stable load situation may be a situation where the vehicle is stopped at a traffic light or a situation where the vehicle is stopped idling for a certain period. The monitoring block 110 determines whether the current situation corresponds to the stable situation based on, for example, speed information from a vehicle speed sensor and external environment information from the external sensor 81.

If it is determined that the situation corresponds to a stable situation, the monitoring block 110 in S23 sets a vehicle load stable flag to ON in S23. On the other hand, if it is determined that the situation does not correspond to the stable situation, S23 is skipped, and the sub-flow ends with the vehicle load stable flag being OFF.

Returning to FIG. 8, in S30 following S20, a noise flag process is executed. The flag process will be explained in detail with reference to the sub-flow in FIG. 11. First, in S31, the monitoring block 110 obtains peak information from the peak hold circuit 4. More specifically, the monitoring block 110 acquires the voltage from the primary circuit 3a of the DC-DC converter 3, that is, the primary component of the voltage in the DC-DC converter 3. For example, as shown in FIG. 5, the monitoring block 110 acquires the maximum voltage value Vmax in the primary circuit 3a from the peak hold circuit 4 as peak information. In the next step S32, the monitoring block 110 obtains a noise difference value. Specifically, the monitoring block 110 calculates and acquires, as the noise difference value, the difference between the maximum voltage value Vmax acquired in the previous step and the input voltage value Vin. The noise difference value is an example of a parameter that indicates the magnitude of the noise.

Then, in S33, the monitoring block 110 determines whether the acquired noise difference value falls outside the allowable noise range. Here, the allowable noise range is a range of noise difference values that are less than or equal to a predetermined threshold value. If it is determined that the noise difference value falls outside the allowable noise range, the monitoring block 110 sets the noise flag to ON in S34. On the other hand, if it is determined that the noise difference value falls within the allowable noise range, S34 is skipped, and the sub-flow ends with the noise flag being OFF. The above processes of S10, S20, and S30 may be executed in a different order or in parallel.

Returning to FIG. 8, in S40, the output block 120 determines whether all the flags in S10, S20, and S30 have been set to on. If all the flags are on, the output block 120 executes a slew rate control, which will be described later, as noise reduction control in S50. On the other hand, if it is determined that at least one flag is off, the output block 120 skips the noise reduction control and ends this flow.

Next, the noise reduction control will be explained in detail. In the noise reduction control, the output block 120 adjusts the slew rate of the voltage variation in the DC-DC converter 3. The spike noise generated by switching tends to become larger as the slew rate increases. Thus, the output block 120 slows down the slew rate by setting the on/off combination of the switches in the gate resistor circuit 32 to increase the gate resistance value. The output block 120 may set the magnitude of the gate resistance value in accordance with the magnitude of the noise difference value acquired in S32.

According to the first embodiment described above, at least one of the rise time tr or the fall time tf of the voltage in the DC-DC converter 3 is controlled based on the time variation of the supply voltage. Thus, the noise reduction control by controlling at least one of the rise time tr or the fall time tf can be executed in consideration of the time variation of the voltage supplied to the in-vehicle device 6. Thus, it is possible to achieve both noise reduction and supply voltage stability.

### Second Embodiment

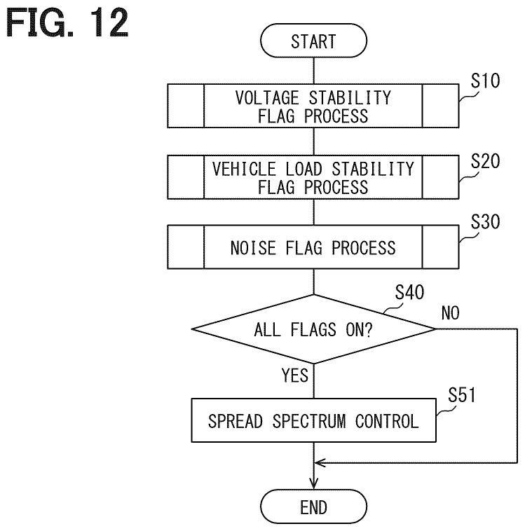

A second embodiment shown in FIG. 12 is a modification of the first embodiment.

In the second embodiment, if all flags are on in S40, the flow proceeds to S51. In S51, spectrum spread control is executed as a noise reduction control. Specifically, the output block 120 in S40 spreads the switching frequency of the switching element 31 in the primary circuit 3a more than the switching frequency when at least one flag is off.

According to the second embodiment described above, at least one of the rise time tr or the fall time tf of the voltage in the DC-DC converter 3 is controlled based on the time variation of the supply voltage. Thus, noise reduction control by controlling the switching frequency can be performed taking into account the time variation in the voltage supplied to the in-vehicle device 6. Thus, it is possible to achieve both noise reduction and supply voltage stability.

### OTHER EMBODIMENTS

Although multiple embodiments have been described above, the present disclosure is not to be construed as being limited to these embodiments, and can be applied to various embodiments and combinations within a scope not deviating from the gist of the present disclosure.

In a modified example, the monitoring block 110 may acquire, in S31, the voltage value from the secondary circuit 3b in the DC-DC converter 3 as peak information. In other words, in this modified example, the peak hold circuit 4 is connected to the secondary circuit 3b. In the next step S32, the monitoring block 110 may calculate and acquire, as a noise difference value, the difference between the maximum voltage value Vmax in the secondary circuit 3b acquired in the previous step and the set voltage value.

In a modified example, the monitoring block 110 may monitor, as the supply voltage, the voltage immediately after it is output from the DC-DC converter 3 and before it is supplied to the in-vehicle device 6.

In a modified example, the DC-DC converter 3 may be of the non-insulated type.

In a modified example, the vehicle system 1 may include multiple DC-DC converters 3. Specifically, the DC-DC converters 3 may output supply voltage to different groups of the in-vehicle devices 6, respectively. In this case, the controller 5 equipped with one dedicated computer may comprehensively control the DC-DC converters 3. Alternatively, controller 5 may include multiple dedicated computers, and dedicated computers may individually control different DC-DC converters 3.

In a modified example, the dedicated computer constituting the controller 5 may be an integrated electronic control unit (ECU) that integrates driving control of the vehicle. The dedicated computer constituting the controller 5 may be a determination ECU that determines driving tasks in the driving control of the vehicle. The dedicated computer constituting the controller 5 may be a monitoring ECU that monitors the driving control of the vehicle. The dedicated computer constituting the controller 5 may be an evaluation ECU that evaluates the driving control of the vehicle.

The dedicated computer constituting the controller 5 may be a navigation ECU that navigates a travel route of the vehicle. The dedicated computer constituting the controller 5 may be a locator ECU that estimates a self-state quantity of the vehicle. The special purpose computer constituting the controller 5 may be an actuator ECU that controls a travel purpose actuator of the vehicle. The special purpose computer constituting the controller 5 may be a human machine interface (HMI) control unit (HCU) that controls information presentation in the vehicle. The dedicated computer constituting the controller 5 may be a computer other than the vehicle, which configures an external center or a mobile terminal that can communicate with the vehicle.

The dedicated computer constituting the controller 5 may include at least one of a digital circuit or an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), or the like. The digital circuit may include a memory storing a program.

In a modification example, the vehicle to which the controller 5 is applied may be an autonomous robot capable of transporting luggage or collecting information by autonomous driving or remote driving. The embodiments and modifications described above may be implemented as a controller 5 that is configured to be mountable on a host mobile body and has at least one processor 102 and at least one memory 101. Specifically, the controller 5 may be implemented in the form of a processing circuit (e.g., a processing ECU) or a semiconductor device (e.g., a semiconductor chip).

1. A controller configured to control a switching converter that is configured to convert a power voltage to a supply voltage according to a switching frequency of the switching converter, the supply voltage being supplied to an in-vehicle device, the controller comprising:
a monitoring unit configured to monitor a time variation of the supply voltage; and
a voltage control unit configured to execute a voltage control in which at least one of a rise time or a fall time of a voltage in the switching converter is controlled based on the time variation of the supply voltage.

2. The controller according to claim 1, wherein
the switching converter includes a switching element, and
the voltage control unit is configured to execute the voltage control by controlling a gate resistance of the switching element.

3. A controller configured to control a switching converter that is configured to convert a power voltage to a supply voltage according to a switching frequency of the switching converter, the supply voltage being supplied to an in-vehicle device, the controller comprising:
a monitoring unit configured to monitor a time variation of the supply voltage; and
a voltage control unit configured to execute a voltage control in which the switching frequency is controlled based on the time variation of the supply voltage, wherein
the voltage control unit is configured to execute the voltage control based on the time variation falling within an acceptable variation range of the in-vehicle device.

4. The controller according to claim 1, wherein
the voltage control unit is configured to execute the voltage control based on the time variation falling within an acceptable variation range of the in-vehicle device.

5. The controller according to claim 4, wherein
the in-vehicle device is one of in-vehicle devices,
a specific in-vehicle device is defined as one of in-vehicle devices that has a minimum value of the acceptable variation range, and
the voltage control unit is configured to execute the voltage control based on the time variation of the supply voltage falling within the acceptable variation range of the specific in-vehicle device.

6. The controller according to claim 1, wherein
the voltage control unit is configured to execute the voltage control based on magnitude of noise in a primary component of a voltage in the switching converter falling outside an acceptable noise range.

7. The controller according to claim 1, wherein
the voltage control unit is configured to execute the voltage control based on a stable load condition being satisfied, and
the stable load condition is satisfied when a variation in a load current in a vehicle falling within an acceptable range.

8. The controller according to claim 1, wherein
the monitoring unit is configured to monitor an input voltage to the in-vehicle device as the supply voltage.
